(19) United States
(12) Patent Application Publication
(10) Pub. No.: US 2006/0215084 A1
(43) Pub. Date: Sep. 28, 2006

(54) Transflective liquid crystal display device

(75) Inventors: Sander Jurgen Roosendaal, Eindhoven (NL); Leo Marie Weegels, Shinoharakitamachi (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/556,326

(22) PCT Filed: May 11, 2004
(86) PCT No.: PCT/IB04/50637

§ 371 Date: Nov. 10, 2005

(30) Foreign Application Priority Data
May 16, 2003 (EP) 03101374.1

(51) Int. Cl. G02F 1/1335

(52) U.S. Cl. 349/114

(57) ABSTRACT

This invention relates to a transflective liquid crystal display device, comprising an upper first substrate (2), a lower second substrate (3), comprising means for defining reflective (12) and transmissive parts (13) of the display. A liquid crystal layer (4) is arranged between the first substrate (2) and the second substrate (3). For the reflective parts (12), a reflective layer (5) is provided to reflect ambient light falling into the display device. The transflective LCD device further comprises an in-cell retardation layer (7) at least for the reflective parts (12), being arranged between said reflective layer (5) and the liquid crystal layer (4). Preferably the in-cell retardation layer (7) also extends over the transmissive parts (13). The inclusion of an in-cell retardation layer (7) makes it possible to achieve transflective liquid crystal optical modes with a high reflection, a high transmission and at the same time a good contrast ratio, for both the reflective (12) and the transmissive (13) parts of the display.

This invention relates to a liquid crystal display device, more particularly to a transflective liquid crystal display device.

Transflective liquid crystal displays, in particular transflective color active matrix liquid crystal displays (AM-LCD), are today commonly used for mobile, handheld applications. Such display devices are preferred due to their comparatively low power consumption and their good front-of-screen performance. A transflective liquid crystal display is a display which works in both a transmissive mode, using light from a backlight, arranged behind the display, and in a reflective mode, using ambient light. Therefore, the transflective display has excellent readability, both under bright and dark conditions.

In particular, the pixels of such a transflective LCD device comprise reflective sub-pixels operating in the reflective mode, and transmissive sub-pixels operating in the transmissive mode.

However, for a transflective AM-LCD, there is often a compromise between optical performance of the reflective and the transmissive sub-pixels, respectively. On the other hand, if the optical performance of the reflective and transmissive modes are adjusted separately, the arrangement will often become difficult to manufacture. Another issue with transflective AM-LCD is that the driving voltages are often quite high, and a display using lower driving voltages is therefore desired.

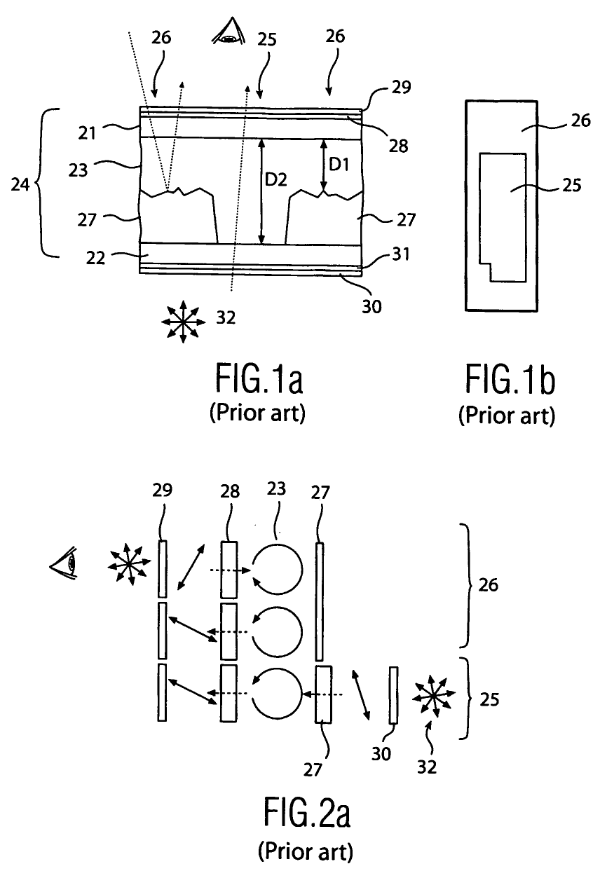

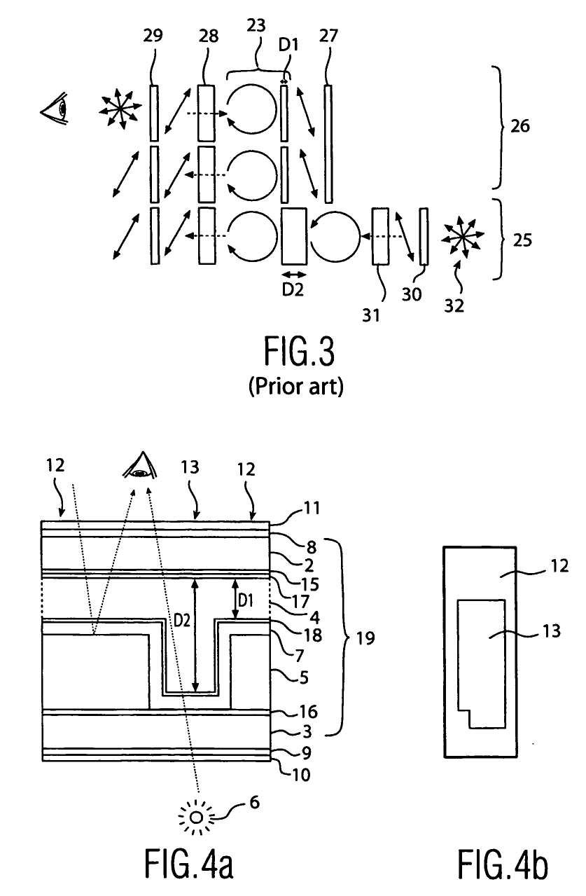

Efforts to overcome some of the above issues have been made. One such example is disclosed in FIGS. 1a and 1b. This device comprises a first and a second substrate 21, 22, between which a layer of liquid crystal material 23 is sandwiched, said components together forming a liquid crystal cell 24. The pixel is subdivided into a transmissive part 25 and a reflective part 26. Moreover, a patterned reflector layer 27 is arranged between the second substrate and the liquid crystal layer, so that the reflector is only present in parts of the pixel, hence defining transmissive and reflective parts 25, 26. The reflector layer 27 is arranged within the cell 24 in order to avoid parallax, and for this reason a retardation foil 28 must be applied as an external foil on the viewing side of the cell. Moreover, the device comprises a front analyzer 29, a back polarizer 30, a back retardation foil 31 and a backlight 32. The optical representation of the transflective pixel in the dark and the bright state, respectively is illustrated in FIG. 2 and FIG. 3.

The optical performance of the display device essentially depends on the following cell parameters: the orientation of the polarizer 30 and the analyzer 29; the cell gap D1 of the reflective sub-pixel; the cell gap D2 of the transmissive sub-pixel, the twist angle of the liquid crystal layer 23 and the number of retardation layers on both sides of the cell (here 28, 31), and their respective orientation and retardation.

By use of the above cell parameters it is possible to optimize the performance parameters regarding: reflectance; transmission; contrast ratio (reflective and transmissive); driving voltage (the same voltage for the reflective and transmissive sub-pixel, preferably as low as possible); the chromaticity of all grey scales; and the viewing angle.

However, with the prior art displays it has proven to be impossible to completely optimize all performance parameters at the same time by varying the above-mentioned cell parameters. Hence, alternative solutions are desired.

One solution that has been proposed in international patent application WO 2003/019276 is to pattern the front (viewer side) retardation layer, in order to enable the use of different retardation values and retarder orientations for the reflective and transmissive sub-pixel, respectively. However, this solution adds the manufacturing step of patterning said retardation layer.

Another solution that has been proposed is to use different twist angles for the transmissive and reflective sub-pixels, but this solution also adds some manufacturing difficulties.

Hence, a further improved display device, which allows optimization as indicated above, overcoming the above problems is desired.

Hence, an object of this invention is to provide a display device that overcomes the above problems with the prior art, and enables an improved performance in a cost-efficient manner.

The above and other objects are at least in part achieved by a transflective liquid crystal display device by way of introduction, comprising an upper first substrate and a lower second substrate, comprising means for defining reflecting and transmitting parts of the display; a liquid crystal layer, arranged between the first substrate and the second substrate; said means including a reflective layer for the reflecting parts, for reflecting ambient light falling into the display device, the reflective layer being arranged between said liquid crystal layer and the second substrate, and an in-cell retardation layer, extending over the reflecting parts of the display and being arranged between said liquid crystal layer and the reflective layer.

An ‘in-cell retardation layer’ should be construed as a retardation layer that is arranged inside the liquid crystalline cell, i.e. between the substrates, as opposed to a conventional retardation layer which is formed externally and then attached to one of the substrates, outside the liquid crystalline cell. More particularly, according to the invention the in-cell retardation layer is arranged on top of the reflective layer, preferably directly on top thereof.

The inclusion of an in-cell retardation layer makes it possible to achieve transflective liquid crystal optical modes with a high reflection, a high transmission and at the same time a good contrast ratio. By including the retarder layer inside the cell it is possible to design new optical modes. The characteristics of the in-cell retarder define extra cell parameters and thus an extra degree of freedom is added in the design. Thereby, the optimization of the above-mentioned display parameters is facilitated. In particular, an LCD device according to the invention may exhibit high reflection, high transmission and a good contrast ratio.

At the same time, this arrangement allows the use of an unpatterned front retardation layer. Hence, the number of mask steps may be relatively low when manufacturing the display, and this also translated into relatively inexpensive production of transflective active matrix liquid crystal displays.

Also, the use of the inventive in-cell retarder enables a thickness reduction of the total liquid crystal module, since the in-cell retarder may be made much thinner than conventional external retardation foils.

Suitably, the in-cell retardation layer extends essentially over both the reflecting and transmitting parts of the display. For the transmissive parts of the display device, the in-cell retardation layer is arranged between the liquid crystal layer and the second substrate, and is preferably positioned directly adjacent the liquid crystal layer. Preferably, the liquid crystal layer is one of a twisted nematic, non-twisted nematic or vertically aligned liquid crystal layer.

According to an embodiment of the invention, the display device further comprises at least one additional retardation layer arranged behind the second substrate. This retardation layer is a conventional retardation layer arranged outside the liquid crystalline cell. By including such layer in the display device, it is possible to compensate for the in-cell retarder for the transmissive sub-pixels, or alternatively, any effects of the in-cell retarder may be altered to any desired other retardation effect for the transmissive state only. It is also possible to include more retardation layers for example in order to improve the compensation for all wavelengths of visible light.

According to one embodiment, the cell gap, i.e. the thickness of the liquid crystal layer, for the transmissive parts is equal to the cell gap of the reflective parts. Preferably, the cell gap for the transmissive parts differs from the cell gap for the reflective parts. This is a so-called dual cell-gap configuration of the transflective LCD device.

Suitably, a transparent pixel electrode is arranged between the in-cell retardation layer and an alignment layer for the liquid crystal layer, in order to reduce the external driving voltage needed. By including such an additional pixel electrode, a voltage drop over the in-cell retardation layer is avoided. The externally applied voltage equals the voltage over the liquid crystal layer, and thus may remain low. This leads to a reduced power consumption and enables the use of less expensive drivers

Preferably, the twist angle of said liquid crystal layer is about 80°-100°, more preferably about 90°. Said in-cell retarder suitably has a retardation of between 100 nm and 180 nm. Further, the effective retardation (dΔn) of the liquid crystal layer is preferably between 150-300 nm in the reflective parts of the display and between 150-600 nm in the transmissive parts of the display. This is conveniently achieved by using a dual cell-gap configuration.

The invention will hereinafter be described in closer detail by means of preferred embodiments thereof with reference to the accompanying drawings.

FIG. 1a is a cross-section view of a transflective electro-optical display pixel of a display device in accordance with the prior art.

FIG. 1b is a top view of the pixel disclosed in FIG. 1a.

FIG. 2 is a schematical optical representation of the light path in the prior art transflective pixel of FIG. 1a, in a dark state.

FIG. 3 is a schematical optical representation of the light path in the prior art transflective pixel of FIG. 1a, in a bright state.

FIG. 4a is a cross-section view of a transflective electro-optical display pixel of a display device in accordance with the invention.

FIG. 4b is a top view of the pixel disclosed in FIG. 4a.

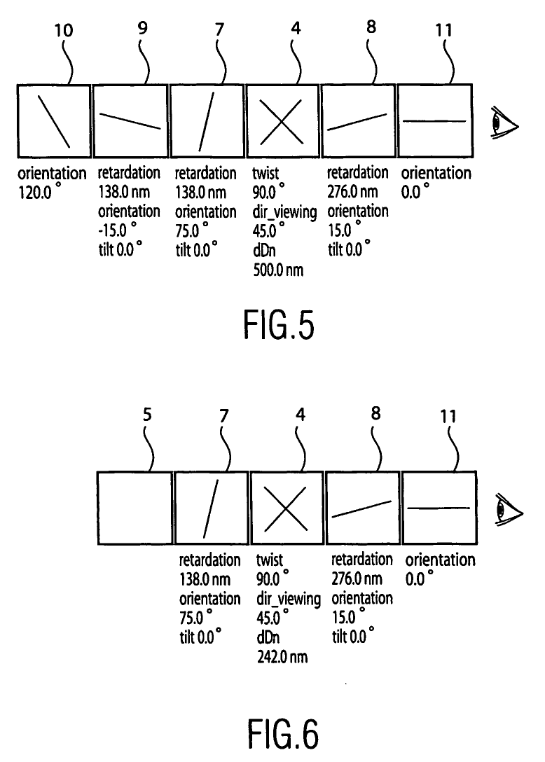

FIG. 5 is a schematic drawing showing the optical layout of the transmissive part of a pixel according to a first embodiment of the invention, in which all layers are shown in a top view, from a viewing side.

FIG. 6 is a schematic drawing showing the optical layout of the reflective part of a pixel according to a first embodiment of the invention, in which all layers are shown in a top view, from a viewing side.

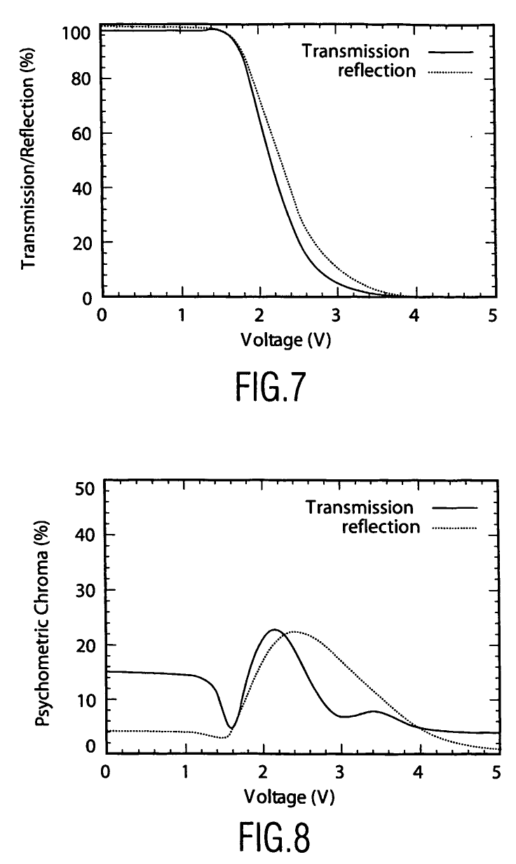

FIG. 7 is a diagram showing the reflection and transmission versus the applied voltage over the liquid crystal cell according to the first embodiment of this invention.

FIG. 8 is a diagram showing the psychometric chromaticity versus the applied voltage over the liquid crystal cell according to the first embodiment of this invention.

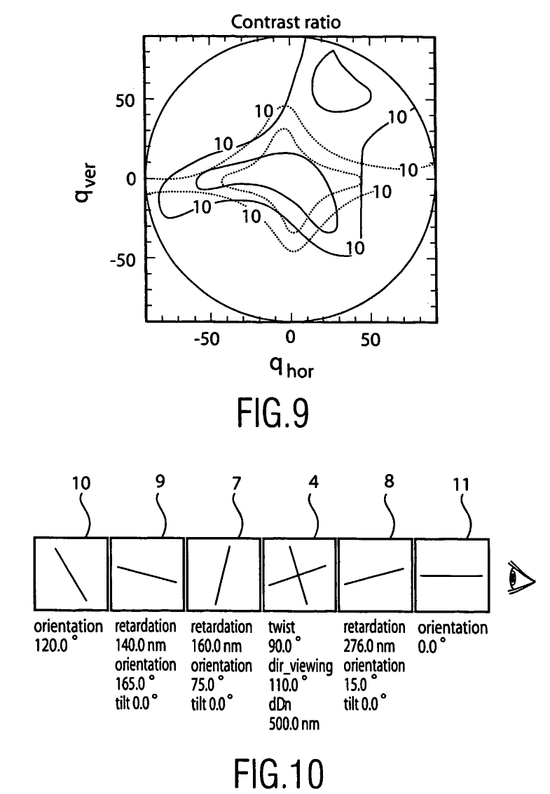

FIG. 9 is a contour plot of the contrast ratio versus the viewing direction for a pixel according to the first embodiment of this invention, where the solid line represents the transmission and the dashed line the reflection.

FIG. 10 is a schematic drawing showing the optical layout of the transmissive part of a pixel according to a second embodiment of the invention, in which all layers are shown in a top view, from a viewing side.

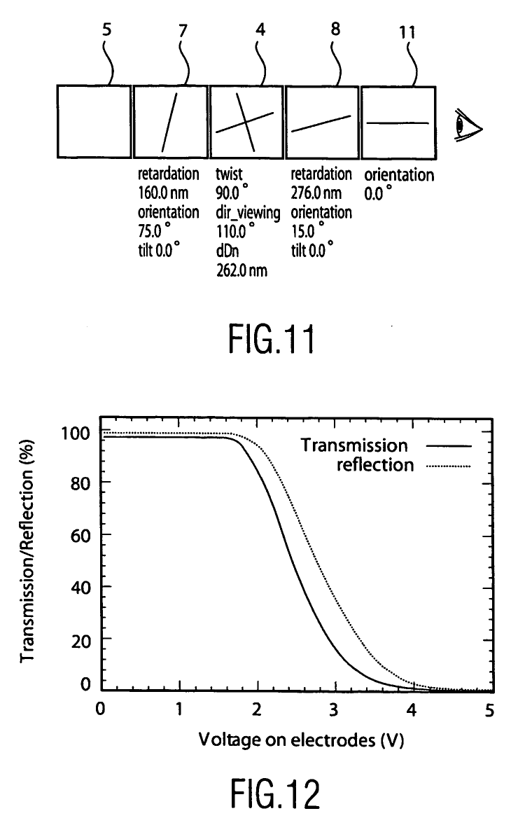

FIG. 11 is a schematic drawing showing the optical layout of the reflective part of a pixel according to a second embodiment of the invention, in which all layers are shown in a top view, from a viewing side.

FIG. 12 is a diagram showing the reflection and transmission versus the applied voltage over the liquid crystal cell according to the second embodiment of this invention.

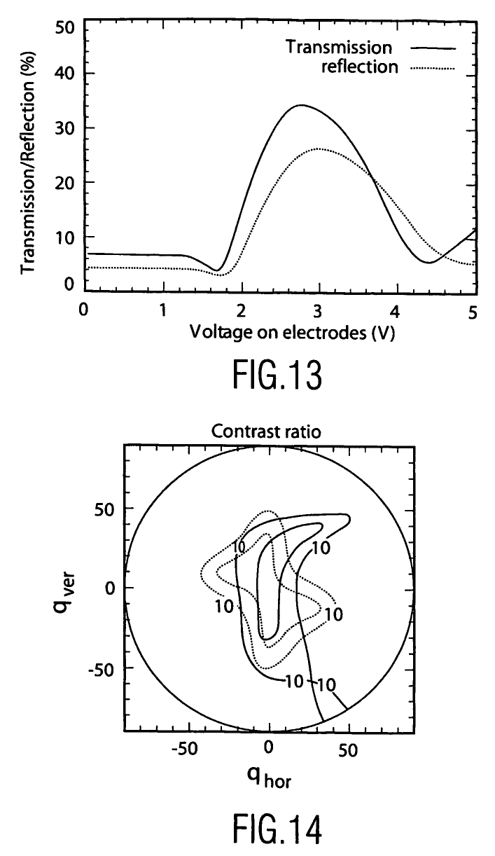

FIG. 13 is a diagram showing the psychometric chromaticity versus the applied voltage over the liquid crystal cell according to the second embodiment of this invention.

FIG. 14 is a contour plot of the contrast ratio versus the viewing direction for a pixel according to the second embodiment of this invention, where the solid line represents the transmission and the dashed line the reflection.

A main embodiment of this invention is disclosed in FIG. 4a and FIG. 4b. FIG. 4a is a cross-section view of a transflective electro-optical display pixel of a display device. A top view of the corresponding electro-optical display pixel is disclosed in FIG. 4b. The electro-optical display pixel is in the present example provided with a twisted nematic liquid crystal material layer 4, being sandwiched between a first and a second substrate 2, 3, together forming a liquid crystal cell 19. In order to control the liquid crystal material 4, the substrates 2, 3 are also provided with electrode structures 15, 16 and alignment layers 17, 18 on per se known manner. On the first substrate 2, a front retardation layer 8 and an analyzer 11 are arranged, and on a back side of said second substrate 3, a back retardation layer 9, a polarizer 10, and a backlight 6 are arranged.

Moreover, according to the invention, a reflection layer 5 is arranged between the liquid crystal layer 4 and the second substrate 3. The reflection layer 5 is patterned, so that a transmissive part 13 and a reflective part 12 of the pixel is formed. In the present example, the cell gap D1 is smaller in the reflective part than the cell gap D2 in the transmissive part of the pixel. Between the reflection layer 5 and the liquid crystal layer 4, an in-cell retardation layer 7 is further arranged. This layer may for example be deposited within the liquid crystal cell by means of liquid crystal network technology. The effect of this layer will be described in further detail below.

### EXAMPLE 1

### (90TN45)

One example of the invention will here be described, with reference to FIG. 5-9.

Here, the liquid crystal layer 4 is a twisted nematic layer with a twist angle of 90° and the orientation of a viewing side director with respect to the analyzer is 45° (This embodiment may be referred to as 90TN45). The schematical layouts for this display are shown in FIG. 5 (for the transmissive mode) and in FIG. 6 (for the reflective mode). As indicated in FIG. 4a, the cell gap D2 of the transmissive part is larger than the cell gap D1 of the reflective part (500 nm versus 242 nm). The in-cell retarder 7 is a uniaxial retarder with a retardation of 138 nm. Further, the back retardation layer 9 is a retarder with the same retardation, i.e. 138 nm, with an orientation that differs 90° from the orientation of the in-cell retarder 7. Hence, the back retardation layer 9 fully compensates for the in-cell retarder 7 in the transmissive part of the pixel.

In FIG. 7, the transmission and reflection versus the voltage is displayed for 30 this optical mode. In this Figure, the voltage on the x-axis is the voltage applied over the liquid crystal layer and the alignment layers. As may be seen from FIG. 7, the reflection and the transmission in the bright state are high, and a very high contrast ratio may be achieved at a relatively low voltage. The reflection and transmission in the bright state are very close to 100%. In the corresponding prior art displays, without the in-cell retarder according to the invention, the reflection in the corresponding optical mode is around 90%, and moreover, a patterned retarder, for example on the front side of the cell, is needed to achieve a transmission of more than 60%. Hence, the inventive arrangement is advantageous as compared to the prior art.

In FIG. 8, the psychometric chroma versus the voltage is disclosed for the 90TN45 optical mode. The chromaticity is a measure of the coloredness of the pixel, and should be well below 50% to be acceptable. As seen in FIG. 8, with the present invention, the chromaticity is well below this level. Moreover, as shown in FIG. 9, the viewing angle characteristics of the inventive display are good. Moreover, the total stack of the display may be rotated, in order to align the directions having best optical performance with the most common viewing angles.

### EXAMPLE 2

### (Low Voltage Solution)

As indicated above with reference to FIG. 7, the voltage on the x-axis of FIG. 7 is the voltage applied over the liquid crystal layer and the alignment layers. However, due to the presence of the inventive retardation layer between the electrode on the lower substrate 3 and the liquid crystal layer 4, the actual voltage over the electrodes (i.e. the voltage provided by a column driver) must be larger. As an example, a retarder 7 is used having a thickness/dielectric constant ratio of d/ε=0.25, then the dark voltage of the optical mode according to example 1 will be at 6.5 V external applied voltage instead of 4.5 V indicated in FIG. 7. Example 2 is aimed at reducing this voltage.

This may be realized by depositing a transparent conductive electrode between the in-cell retarder 7 and the alignment layer 18 in FIG. 4a. A through contact through the retarder 7 is then desired. However, this solution results in increased production costs due to an increased number of mask and processing steps. Moreover, since the transmission of the transparent conductive electrode (ITO) is only about 80%-90%, the brightness of the display will be decreased.

Alternatively, the above voltage may be reduced by adapting the optical mode in order to compensate for the loss over the retarder layer. One example of the latter alternative will here be described, with reference to FIGS. 10-14.

Here, the liquid crystal layer 4 is a twisted nematic layer with a twist angle of 90° and the orientation of a viewing side director with respect to the analyzer is 110° (This embodiment is referred to as the low voltage solution). The schematical layouts for this display are shown in FIG. 10 (for the transmissive mode) and in FIG. 11 (for the reflective mode). As indicated in FIG. 4a, the cell gap of the transmissive part is larger than the cell gap of the reflective part (here corresponding to a retardation of 500 nm versus 262 nm). The in-cell retarder 7 is a uniaxial retarder with a retardation of 160 nm. Further, the back retardation layer 9 is a retarder with the retardation 140 nm and with an orientation that differs 90° from the orientation of the in-cell retarder 7.

In FIG. 12, the transmission and reflection versus the voltage is displayed for this low voltage optical mode. In this Figure, the voltage on the x-axis is the voltage applied over the electrodes, assuming an in-cell retarder 7 of 1 μm thickness and ε=4. If plotted in the corresponding way as in FIG. 7, the dark voltage would be around 3 V, and as may be seen from FIG. 12, the column driver voltage is below 5 V. In FIG. 13 it may be seen that the chromaticity values of this embodiment are slightly larger than those in the first example above (see FIG. 8). Also, from FIG. 14 it may be seen that the viewing angle is somewhat decreased as compared to the example above, disclosed in FIG. 9.

It should however be noted that the above-described embodiments and examples of the invention are not to be construed as limiting the invention, but are rather given as examples of how the present invention may be utilized. A man skilled in the art will be able to design many alternative embodiments of this invention, without departing from the spirit and scope of this invention, as defined by the appended claims.

1. A transflective liquid crystal display device, comprising:
an upper first substrate and a lower second substrate, comprising means for defining reflecting and transmitting parts of the display;
a liquid crystal layer, arranged between the first substrate and the second substrate;
said means including a reflective layer for the reflecting parts, for reflecting ambient light falling into the display device, the reflective layer being arranged between said liquid crystal layer and the second substrate, and
an in-cell retardation layer, extending over the reflecting parts of the display and being arranged between said liquid crystal layer and the reflective layer.

2. A display device as in claim 1, wherein the in-cell retardation layer extends essentially over both the reflecting and transmitting parts of the display.

3. A display device as in claim 1, wherein the liquid crystal layer is one of a twisted nematic, non-twisted nematic or vertically aligned liquid crystal layer.

4. A display device according to claim 1, further comprising at least one additional retardation layer arranged behind the second substrate.

5. A display device according to claim 1, wherein the cell gap of the transmissive part is equal to the cell gap of the reflective part.

6. A display device according to claim 1, wherein the cell gap of the transmissive part differs from the cell gap of the reflective part.

7. A display device according to claim 1, wherein transparent pixel electrode is arranged between the in-cell retardation layer and an alignment layer in proximity with said second substrate.

8. A display device according to claim 1, wherein the twist angle of said liquid crystal layer is about 80°-100°, preferably about 90°.

9. A display device according to claim 1, wherein said in-cell retarder has a retardation of between 100 nm and 180 nm.

10. A display device according to claim 1, wherein the effective retardation (dΔn) of the liquid crystal layer is between 150-300 nm in the reflective part of the display and between 150-600 nm in the transmissive part of the display.
